(19) United States
(12) Patent Application Publication
(10) Pub. No.: US 2007/0230716 A1
(43) Pub. Date: Oct. 4, 2007

(54) Vehicular active sound control apparatus

(75) Inventors: Yasunori Kobayashi, Utsunomiya-shi (JP); Toshio Inoue, Shioya-gun (JP); Akira Takahashi, Shioya-gun (JP); Kosuke Sakamoto, Utsunomiya-shi (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD

(21) Appl. No.: 11/727,678

(22) Filed: Mar. 28, 2007

(30) Foreign Application Priority Data
Mar. 29, 2006 (JP) 2006-92192

(51) Int. Cl. H04B 1/00

(52) U.S. Cl. 381/86

(57) ABSTRACT

A vehicular active sound control apparatus has a controller which opens a switch to prevent an uncomfortable sound from being generated by a speaker based on a control signal if the value of a drive signal for the speaker has exceeded a predetermined threshold successively a predetermined number of times.

### BACKGROUND OF THE INVENTION

1. Field of the Invention

The present invention relates to a vehicular active sound control apparatus for generating a sound effect in a vehicle cabin depending on the rotational speed of the engine on the vehicle.

2. Description of the Related Art

Heretofore, there has been proposed in the art a vehicular active sound control apparatus for detecting an accelerating or decelerating action made by a passenger (driver) on a motor vehicle, and producing and radiating a sound effect depending on the acceleration or deceleration through a speaker installed in a vehicle cabin into the vehicle cabin, as disclosed in Japanese Laid-Open Patent Publication No. 54-8027.

According to the disclosed vehicular active sound control apparatus, when the rotational speed of the engine mounted on the motor vehicle increases in response to an accelerating action made by the passenger, a sound effect having a high frequency and a large sound level is generated depending on the increase in the engine rotational speed and radiated from the speaker into the vehicle cabin to create a staged sound atmosphere in the vehicle cabin.

A noise reduction apparatus for use in motor vehicles has also been proposed as disclosed in Japanese Laid-Open Patent Publication No. 5-66780.

When noise is generated by a mechanical signal propagated from the engine on a motor vehicle, the disclosed noise reduction apparatus calculates a secondary sound signal for canceling out the noise from a vibration frequency and generates a secondary sound from a speaker based on the secondary sound signal. When the secondary sound signal significantly increases, the noise reduction apparatus judges that it amplifies the noise, and automatically interrupts the generation of the secondary sound from the speaker.

The conventional vehicular active sound control apparatus referred to above employs a feed-forward control process depending on the engine rotational speed. Therefore, the conventional vehicular active sound control apparatus may possibly continue to output abnormal sounds from the speaker due to aging, performance variations of mass-produced parts, and erroneously installed parts of either one of a preamplifier, a mixer for mixing a sound effect with an audio signal of a vehicular entertainment system, and a main amplifier for driving the speaker.

When the secondary sound signal unusually increases out of a normal range, the above conventional noise reduction apparatus operates to stop outputting the secondary sound from the speaker. Therefore, the noise reduction apparatus also tends to instantaneously stop outputting the secondary sound when the secondary sound signal instantaneously increases out of the normal range due to noise or the like. Such a control process may not be appropriate in the operation of the noise reduction apparatus.

### SUMMARY OF THE INVENTION

It is an object of the present invention to provide a vehicular active sound control apparatus which is capable of preventing abnormal sounds (uncomfortable sounds) from being output from a speaker regardless of aging, performance variations of mass-produced parts, and erroneously installed parts of either one of a preamplifier, a mixer for mixing a sound effect with an audio signal of a vehicular entertainment system, and a main amplifier for driving the speaker.

Another object of the present invention is to provide a vehicular active sound control apparatus which is capable of preventing abnormal sounds from being output from a speaker and outputting a normal sound effect from the speaker regardless of aging, performance variations of mass-produced parts, and erroneously installed parts of either one of a preamplifier, a mixer for mixing a sound effect with an audio signal of a vehicular entertainment system, and a main amplifier for driving the speaker.

A vehicular active sound control apparatus according to the present invention includes a waveform data table for storing waveform data in one cyclic period, a reference signal generating means for generating a reference signal by successively reading the waveform data from the waveform data table, a running state detecting means for detecting a running state of a vehicle, a control means for generating a control signal by acoustically changing the reference signal depending on the running state of the vehicle detected by the running state detecting means, and an output means for acoustically outputting a drive signal based on the control signal, wherein the control means inhibits the control signal from being generated if the value of the drive signal has exceeded a predetermined threshold successively a predetermined number of times.

With the above arrangement, when the value of the drive signal that is acoustically output from the output means exceeds the predetermined threshold successively the predetermined number of times, the control signal is inhibited from being generated. Therefore, the output means can be prevented from generating an uncomfortable sound. If the value of the drive signal instantaneously exceeds the threshold value due to noise or the like, then the control signal is not inhibited from being generated. The control means thus performs an appropriate control process.

The control means calculates an amplification ratio of the control signal and the drive signal, and adjusts the value of the control signal depending on the calculated amplification ratio. Therefore, the value of the drive signal can be adjusted to a desired value.

The vehicular active sound control apparatus also has an alarm means for generating an alarm signal. The control means activates the alarm means if the amplification ratio of the control signal and the drive signal has exceeded a predetermined value. It is thus possible to appropriately determine whether parts placed between the control signal and the drive signal have failed or not.

The vehicular active sound control apparatus also has an amplifier for amplifying the control signal at a predetermined amplification ratio and outputting the amplified control signal, wherein the drive signal comprises the amplified control signal. Therefore, it is possible to appropriately determine whether the amplifier, which may be a plurality of amplifiers, has failed or not.

The vehicular active sound control further has a vehicular entertainment system including an audio signal source and a mixer for mixing an audio signal from the audio signal source and the control signal or an amplified control signal with each other and outputting a mixed signal, wherein the drive signal comprises the mixed signal. Accordingly, the output means, typically a speaker, can be prevented from outputting an abnormal sound (an uncomfortable sound) and is capable of outputting a normal sound regardless of aging, performance variations of mass-produced parts, and erroneously installed parts of either one of a preamplifier, a mixer for mixing a sound effect with an audio signal of a vehicular entertainment system, and a main amplifier for driving the speaker.

According to the present invention, the speaker can be prevented from outputting an abnormal sound and is capable of outputting a normal sound regardless of aging, performance variations of mass-produced parts, and erroneously installed parts of either one of the preamplifier, the mixer for mixing a sound effect with an audio signal of the vehicular entertainment system, and the main amplifier for driving the speaker.

According to the present invention, the vehicular active sound control apparatus can be prevented from generating an uncomfortable sound due to active sound control failures.

In the event of, for example, aging, performance variations of mass-produced parts, and erroneously installed parts of either one of the preamplifier, the mixer for mixing a sound effect with an audio signal of the vehicular entertainment system, and the main amplifier for driving the speaker, the speaker can be prevented from outputting an abnormal sound. Also, the speaker can be prevented from outputting an abnormal sound, i.e., an uncomfortable sound, and is capable of outputting a normal sound, i.e., a normal sound effect.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a vehicular active sound control apparatus according to a first embodiment of the present invention;

FIG. 2A is a diagram showing a measured gain characteristic curve;

FIG. 2B is a diagram showing a gain characteristic curve which is an inversion of the measured gain characteristic curve;

FIG. 2C is a diagram showing a corrected gain characteristic curve;

FIG. 2D is a diagram showing a gain characteristic curve with enhanced gains in a certain frequency range;

FIG. 2E is a diagram showing the inverted gain characteristic curve with enhanced gains in the certain frequency range;

FIG. 3A is a diagram showing waveform data stored in a waveform data memory of the vehicular active sound control apparatus;

FIG. 3B is a diagram showing a sine wave which is generated by referring to the waveform data memory;

FIG. 4 is a diagram showing the frequency characteristics of sound pressure levels before and after they are corrected;

FIG. 5 is a flowchart of an operation sequence of the vehicular active sound control apparatus according to the first embodiment;

FIG. 6 is a diagram showing a waveform illustrative of the operation sequence of the vehicular active sound control apparatus according to the first embodiment;

FIG. 7 is a block diagram of a vehicular active sound control apparatus according to a second embodiment of the present invention; and

FIG. 8 is a flowchart of an operation sequence of the vehicular active sound control apparatus according to the second embodiment.

### DESCRIPTION OF THE PREFERRED EMBODIMENTS

Embodiments of the present invention will be described below with reference to the drawings.

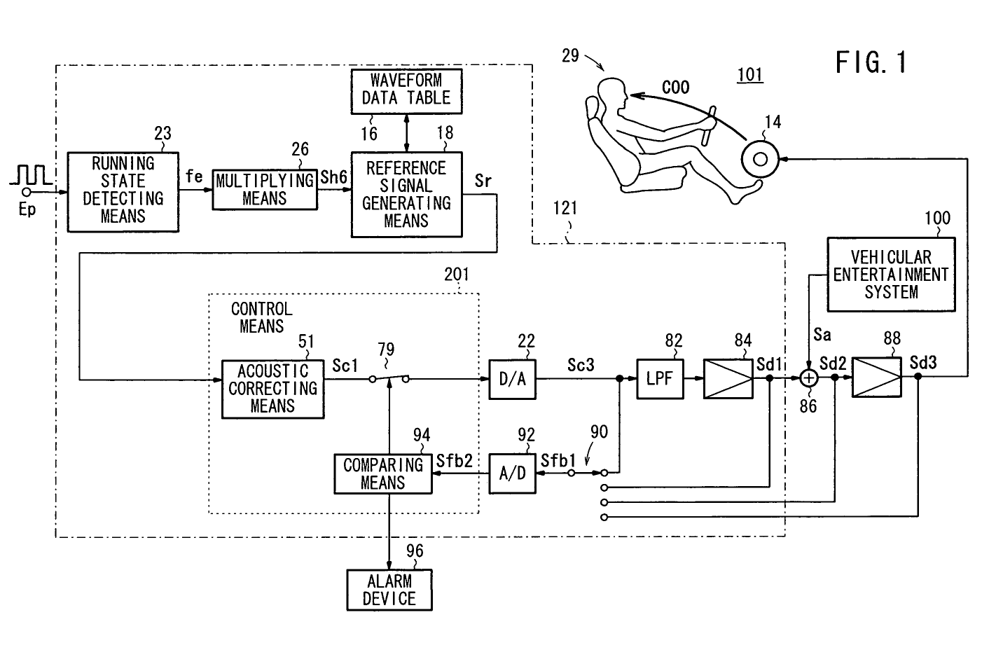

FIG. 1 shows in block form a vehicular active sound control apparatus 101 according to a first embodiment of the present invention.

As shown in FIG. 1, the vehicular active sound control apparatus 101, which is mounted on a motor vehicle, basically comprises a section in the form of an ECU (Electronic Control Unit) 121 serving as a general control means for generating a control signal Sc1 for an active sound effect, etc., a vehicular entertainment system 100 such as an audio system, a video system, a navigation system, or the like for outputting an audio signal Sa, and a speaker 14 serving as an output means for acoustically outputting a drive signal Sd3. The vehicular active sound control apparatus 101 is actually incorporated as an optional unit in the vehicular entertainment system 100.

The section in the form of the ECU 121 is mounted in the dashboard of the motor vehicle, and basically has a waveform data table 16 for storing waveform data in one cyclic period, a reference signal generating means 18 for generating a reference signal Sr which has a harmonic (harmonic signal) Sh based on an engine rotation frequency fe of the motor vehicle by successively reading waveform data from the waveform data table 16, and a control means 201 for generating a control signal Sc1 by acoustically changing the reference signal Sr.

The speaker 14 serves to apply sounds to a passenger in a passenger position 29 such as a driver seat or a front passenger seat. The speaker 14 is fixedly disposed on a panel in each of front doors on the opposite sides of the motor vehicle or on each of kick panels on the opposite sides of the motor vehicle, i.e., door-side inner panel surfaces alongside of a driver leg space. The speaker 14 may alternatively be disposed beneath the center of the dashboard.

The control signal Sc1 generated by an acoustic correcting means 51 of the control means 201 of the ECU 121 is supplied through a switch 79, which functions as a control signal generation inhibiting means, to a D/A converter 22, which converts the control signal Sc1 into an analog control signal Sc3. A high-frequency noise component of the control signal Sc3 is cut off by a low-pass filter 82. The control signal Sc3 is then amplified by a preamplifier 84 into a drive signal (amplification control signal) Sd1, which is mixed with the audio signal Sa by a mixer 86. The mixer 86 generates a mixed signal as a drive signal (amplification control signal) Sd2, which is then amplified by a main amplifier 88 into a drive signal (amplification control signal) Sd3.

The speaker 14 acoustically outputs the drive signal Sd3 based on the control signal Sc1. Stated otherwise, the speaker 14 converts the drive signal Sd3 into an acoustic signal as a sound effect, and outputs the sound effect into the vehicle cabin.

The gain of the main amplifier 88 can be changed by the passenger.

The reference signal generating means 18 has an input port connected to a series-connected circuit comprising a running state detecting means 23 such as a frequency counter or the like for detecting, as a running state of the vehicle, the frequency of engine pulses Ep which are measured with a Hall-effect device or the like when the output shaft of the engine mounted on the motor vehicle rotates, and a multiplying means 26 for outputting a harmonic signal Sh6 which has a frequency (sixth harmonic frequency) 6fe that is six times the engine rotation frequency fe (fundamental frequency) detected by the running state detecting means 23. The multiplying means 26 may multiply the engine rotation frequency fe by an integer such as 2, 3, 4, 5, 6, . . . a real number such as 2.5, 3.3, . . . .

The control signal Sc3 and the drive signals Sd1, Sd2, Sd3 are supplied to respective fixed ports of a multiplexer 90 in the ECU 121. The multiplexer 90 selects either one of the control signal Sc3 and the drive signals Sd1, Sd2, Sd3 supplied to the fixed ports and supplies the selected signal as a feedback signal Sfb1 to a common port thereof.

The feedback signal Sfb1 is then converted by an A/D converter 92 into a digital feedback signal Sfb2, which is supplied to a comparing means 94 of the control means 201.

The comparing means 94 compares the values of the control signal Sc3 and the drive signals Sd1, Sd2, Sd3 with respective predetermined thresholds given for those signals. If the value of either one of the control signal Sc3 and the drive signals Sd1, Sd2, Sd3 exceeds the corresponding threshold successively a predetermined number of times, then the comparing means 94 operates an alarm device 96 such as a buzzer or a speech synthesizer to generate an alarm signal, and turns off or opens the switch 79 to disconnect the acoustic correcting means 51 and the D/A converter 22 from each other, thereby virtually inhibiting the control signal Sc1 from being generated by the control means 201.

Between the speaker 14 and the passenger position (front-seat passenger position) 29, there are provided inherent acoustic characteristics (sound-field characteristics, frequency transfer characteristics, or sound-field gain characteristics) C00 due to the passenger cabin structure of the motor vehicle, the materials used in the passenger cabin of the motor vehicle, etc. The sound-field gain characteristics C00 have complex disturbances such as peaks and dips in the responses thereof because of the passenger cabin structure, the materials used, etc.

The sound-field gain characteristics C00 are obtained as gain frequency characteristics (hereinafter simply referred to as gain characteristics or frequency characteristics) representing the ratio of the amplitude (magnitude) to frequency of a signal that is output from a microphone which serves as a sound detecting means disposed in the front seat passenger position 29, or specifically at the position of an ear of the passenger in the front seat passenger position 29, when the frequency of a sine-wave signal having a constant amplitude that is applied as the control signal Sc to the speaker 14 is continuously varied from lower to higher frequencies. The frequency of a sine-wave signal, which is referred to above, is not the engine rotation frequency, but the frequency of an acoustic signal.

Stated otherwise, the sound-field gain characteristics C00 represent gain characteristics obtained at the front seat passenger position 29 when the reference signal generating means 18 and the D/A converter 22 are directly connected to each other, without the control means 201 interposed therebetween, and the frequency of a sine-wave signal having a constant amplitude that is generated by the reference signal generating means 18 is continuously varied from a lower frequency such as several tens [Hz] to a higher frequency such as 1 [kHz]. The gain represented by the gain characteristics C00 changes depending on the frequency of the reference signal Sr from the speaker 14 to the front seat passenger position 29. More strictly, the gain represented by the gain characteristics C00 changes depending on the frequency of the reference signal Sr from the reference signal generating means 18 to the front seat passenger position 29.

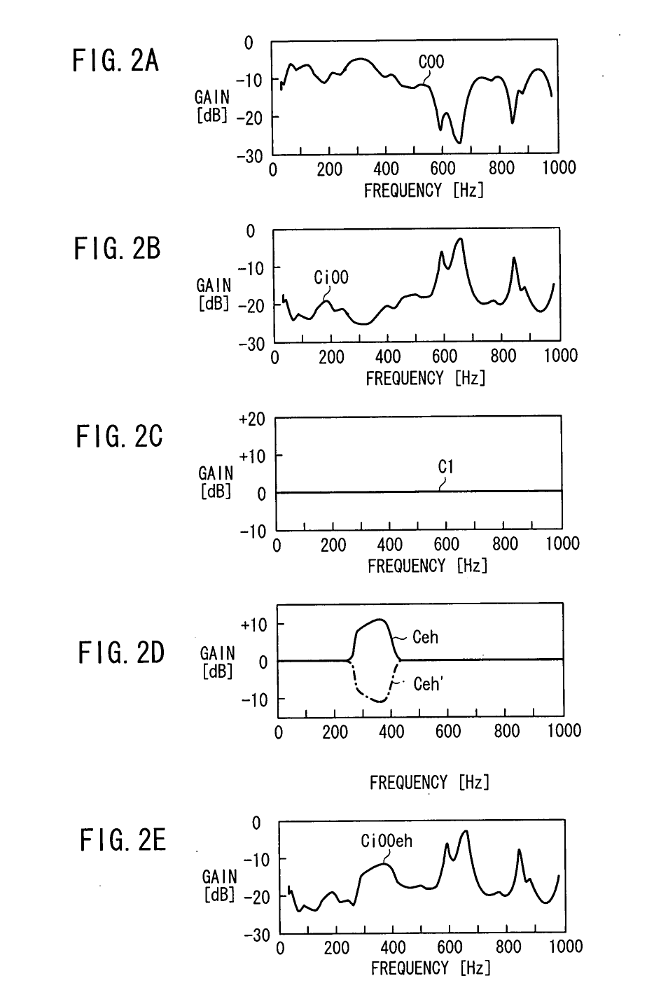

FIG. 2A shows a gain characteristic curve C00, actually measured in a frequency range from about 30 [Hz] to about 970 [Hz], which represents sound-field characteristics from the position of the speaker 14 to the front seat passenger position 29, or more exactly to the positions of the ears of the passenger. The horizontal axis of FIG. 2A represents frequencies [Hz] and the vertical axis gains [dB].

The reference signal Sr is generated as follows: The waveform data table 16 is stored in a memory.

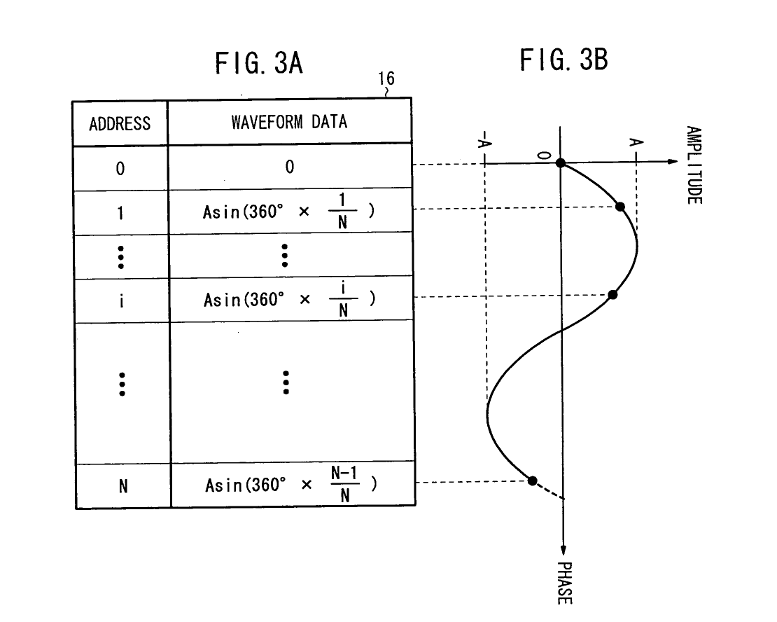

As schematically shown in FIGS. 3A and 3B, the waveform data table 16 comprises instantaneous value data stored as waveform data at respective addresses, the instantaneous value data representing a predetermined number (N) of instantaneous values into which the waveform of a sine wave in one cyclic period is divided at equal intervals along a time axis (=phase axis). The addresses (i) are indicated by integers (i=0, 1, 2, . . . , N−1) ranging from 0 to (the predetermine number−1). The alphabetical letter A shown in FIGS. 3A and 3B is represented by 1 or any desired positive real number. Therefore, the waveform data at the address i is calculated as A sin (360°×i/N). Stated otherwise, one cycle of sine waveform is divided into N sampled values at sampling points spaced over time, and data generated by quantizing the instantaneous values of the sine wave at the respective sampling points are stored as waveform data at respective addresses, which are represented by the respective sampling points, in the memory.

The reference signal generating means 18 generates a reference signal Sr, which comprises a sine-wave signal having a frequency corresponding to the frequency of the harmonic signal Sh6, when it reads the waveform data from the waveform data table 16 while changing the readout address period depending on the period of the harmonic signal Sh6 that is applied to the reference signal generating means 18.

The acoustic correcting means 51 of the control means 201 functions as a filter whose gain characteristics (having a horizontal axis representing frequencies and a vertical axis representing gains) are represented by a gain characteristic curve (inverted gain characteristic curve) Ci00 shown in FIG. 2B which is an inversion of the gain characteristic curve C00 shown in FIG. 2A that changes depending on the frequency of the reference signal Sr from the speaker 14 to the front seat passenger position 29.

The inverted gain characteristic curve Ci00 is such a gain characteristic curve that it has an increased gain level at frequencies where acoustically less transmissive dips are present in the gain characteristic curve C00 shown in FIG. 2A and a reduced gain level at frequencies where acoustically more transmissive peaks are present in the gain characteristic curve C00 shown in FIG. 2A. The inverted gain characteristic curve Ci00 is expressed by an expression (transfer function) as Ci00=B/C00 where B represents a reference value.

In the thus-configured vehicular active sound control apparatus 101, when the reference signal generating means 18 generates a reference signal Sr having a constant amplitude in a frequency range from 30 [Hz] to 970 [Hz], the corrective gain characteristic curve Ci00 of the acoustic correcting means 51 and the sound-field gain characteristic curve C00 are multiplied at the front seat passenger position 29, producing gain characteristics C1 according to which sounds having a flat sound pressure level in the frequency range are heard at the front seat passenger position 29, as indicated by a gain characteristic curve C1 in FIG. 2C.

Therefore, when the cyclic period of the engine pulses Ep changes or remains constant as the passenger accelerates or decelerates the motor vehicle or keeps the motor vehicle running at a constant speed, the reference signal generating means 18 generates a sine-wave reference signal Sr whose frequency increases, decreases, or remains constant substantially in real time, depending on the harmonic signal Sh6 having a sixth-harmonic frequency 6fe produced by the multiplying means 26 from the engine rotation frequency fe that is detected by the running state detecting means 23.

The reference signal Sr is converted into a control signal Sc1 that has been corrected by the gain characteristic curve Ci00 of the acoustic correcting means 51. The sound effect output from the speaker 14 is prevented from changing depending on the frequency at the front seat passenger position 29 due to the vehicle cabin acoustic characteristics C00. Therefore, flat gain vs. frequency characteristics are available at the front seat passenger position 29. The sound effect generated at the front seat passenger position 29 can be thus made linear depending on the engine rotational speed (six times the engine rotation frequency fe), or stated otherwise depending on the state of the noise source.

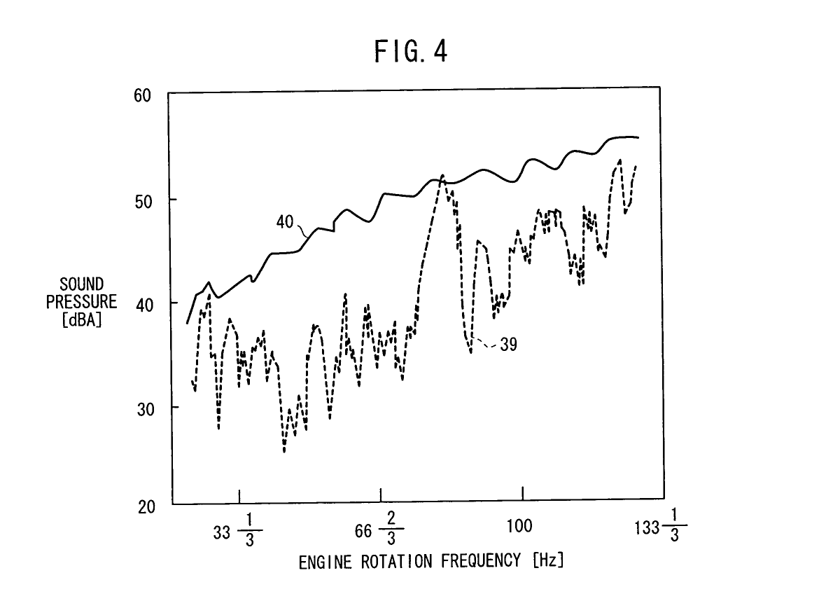

FIG. 4 shows frequency characteristics of sound pressure levels at the front seat passenger position 29 before and after they are corrected. To make the sound effect more linear in achieving the frequency characteristics shown in FIG. 4, the reference signal Sr or the control signal Sc1 is generated so as to have its amplitude increasing in proportion to the engine rotation frequency fe.

As shown in FIG. 4, a corrected characteristic curve 40 has its sound pressure level [dBA] changing more linearly depending on the engine rotation frequency fe than an uncorrected characteristic curve 39 having complex disturbances such as dips and peaks.

The process referred to above for generating at the front seat passenger position 29 the sound effect which changes linearly as the engine rotation frequency fe increases or the motor vehicle is accelerated will be referred to as a sound field adjusting process or a flattening process.

The acoustic correcting means 51 provides a joint gain characteristic curve Ci00eh by joining a gain characteristic curve Ceh having increased gains in a certain frequency range, e.g., a frequency range from 300 [Hz] to 450 [Hz], for example, as indicated by the solid line in FIG. 2D, and the gain characteristic curve Ci00, as shown in FIG. 2E. The joint gain characteristic curve Ci00eh shown in FIG. 2E has higher gains, i.e., produces higher sound pressure levels, in the frequency range from 300 [Hz] to 450 [Hz] than the inverted gain characteristic curve Ci00 shown in FIG. 2B. The acoustic correcting means 51 may provide a gain characteristic curve Ceh′ indicated by the dotted line in FIG. 2D at the front seat passenger position 29 for thereby reducing gains or lowering sound pressure levels in the above frequency range. The process referred to above for emphasizing an acoustic signal only at desired frequencies is referred to as a frequency emphasizing process.

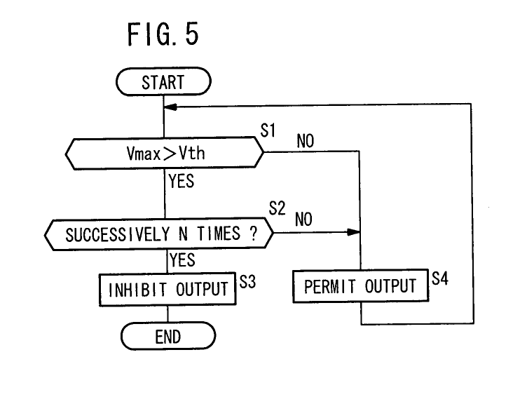

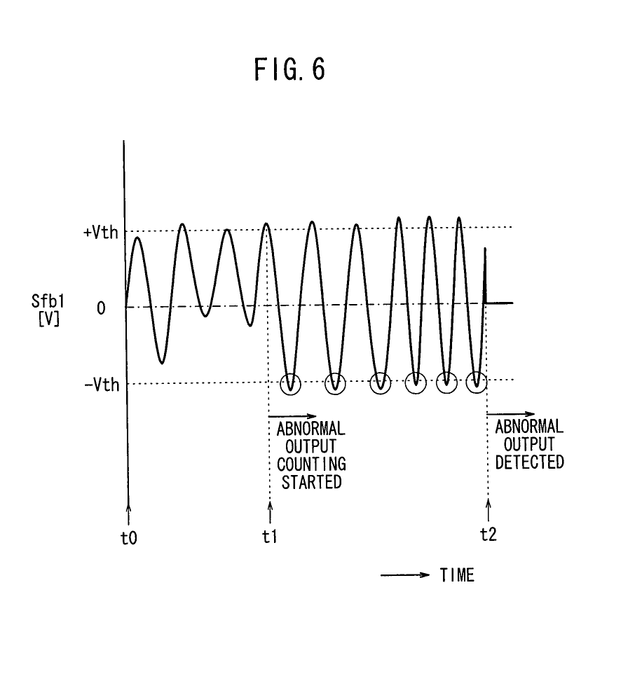

A process of preventing unstable operation of the vehicular active sound control apparatus 101, which is basically configured and operates, according to the first embodiment will be described below with reference to a flowchart shown in FIG. 5 and a waveform shown in FIG. 6.

### 1st Embodiment

When the control signal Sc1 output from the control means 201 is output as the control signal Sc3 from the D/A converter 22 while the vehicular active sound control apparatus 101 is in operation, the control signal Sc3 passes through the low-pass filter 82 and is amplified into the drive signal Sd1 by the preamplifier 84. The drive signal Sd1 and the audio signal Sa are mixed by the mixer 86 into the drive signal Sd2, which is amplified by the main amplifier 88 into the drive signal Sd3. The speaker 14 outputs a sound effect based on the drive signal Sd3.

While the vehicular active sound control apparatus 101 is thus in operation, in step S1, the multiplexer 90 selects one of the control signal Sc3 and the drive signals Sd1, Sd2, Sd3 as the feedback signal Sfb1 (Sc3, Sd1, Sd2, or Sd3), which is converted by the A/D converter 92 into the feedback signal Sfb2 (Sc3, Sd1, Sd2, or Sd3) that is supplied to the control means 201. In the control means 201, the comparing means 94 determines whether a maximum voltage value Vmax of the feedback signal Sfb2 exceeds a threshold voltage Vth, which is given for the selected one of the control signal Sc3 and the drive signals Sd1, Sd2, Sd3, or not.

If it is judged that the maximum voltage value Vmax is not in excess of the threshold voltage Vth in step S1, then the switch 79 remains closed. In step S4, the control signal Sc1 is permitted to be continuously output from the control means 201 to the D/A converter 22. Therefore, the speaker 14 continuously outputs the sound effect into the vehicle cabin.

If either one of the maximum voltage values Vmax of the feedback signals Sfb2 corresponding respectively to the control signal Sc3 and the drive signals Sd1, Sd2 and Sd3, exceeds the threshold voltage Vth in step S1 at time t1 shown in FIG. 6, then it is determined in step S2 whether the maximum voltage value Vmax exceeds the threshold voltage Vth successively a predetermined number n of times (n≧2, here six times as indicated by ◯ in FIG. 6) or not. Until the maximum voltage value Vmax exceeds the threshold voltage Vth successively the predetermined number n of times, the control signal Sc1 is permitted to be continuously output from the control means 201 to the D/A converter 22 in step S4. If the count of abnormal outputs reaches “n” at time t2 shown in FIG. 6, then it is judged in step S2 that the maximum voltage value Vmax has exceeded the threshold voltage Vth successively the predetermined number n of times at time (see time t2).

If the answer to step S2 is YES, then the switch 79 is opened and the vehicular active sound control apparatus 101 stops outputting the sound effect from the speaker 14, i.e., inhibits the sound effect from being output from the speaker 14 in step S3. After time t2 shown in FIG. 6, the value of the feedback signal Sfb1 corresponding to the output voltage of the sound effect is made nil.

In step S3, the alarm device 96 simultaneously indicates an abnormal output state.

According to the first embodiment, as described above, the vehicular active sound control apparatus 101 has the waveform data table 16 for storing waveform data in one cyclic period, the reference signal generating means 18 for generating a reference signal Sr by successively reading waveform data from the waveform data table 16, the running state detecting means 23 for detecting a running state of the vehicle, the control means 201 for generating a control signal Sc1 by acoustically changing the reference signal Sr in the running state of the motor vehicle which is detected by the running state detecting means 23, and the speaker 14 as the output means for acoustically outputting the drive signal Sd3 based on the control signal Sc1. When the value of either one of the control signal Sc3 and the drive signals Sd1, Sd2, Sd3 has exceeded the corresponding threshold Vth the predetermined number n of times, the control means 201 opens the switch 79 to virtually inhibit the control signal Sc1 from being generated. Therefore, the speaker 14 is prevented from outputting uncomfortable sounds. If the value of either one of the control signal Sc3 and the drive signals Sd1, Sd2, Sd3 as the feedback signals Sfb1 has instantaneously exceeded the corresponding threshold Vth due to noise or the like, the control means 201 does not virtually inhibit the control signal Sc1 from being generated. Accordingly, the control process performed by the control means 201 is appropriate.

In the first embodiment, the running state of the motor vehicle which is detected by the running state detecting means 23 is represented by the frequency of engine pulses Ep which are measured with a Hall-effect device or the like when the output shaft of the engine mounted on the motor vehicle rotates. However, in place of the frequency of engine pulses Ep, the running state of the motor vehicle may be represented by a change in an engine load as indicated by an air flow rate or an air pressure in the intake manifold, a throttle valve opening, or the like, or a change in a vehicle acceleration or the like.

A second embodiment of the present invention will be explained below.

### 2nd Embodiment

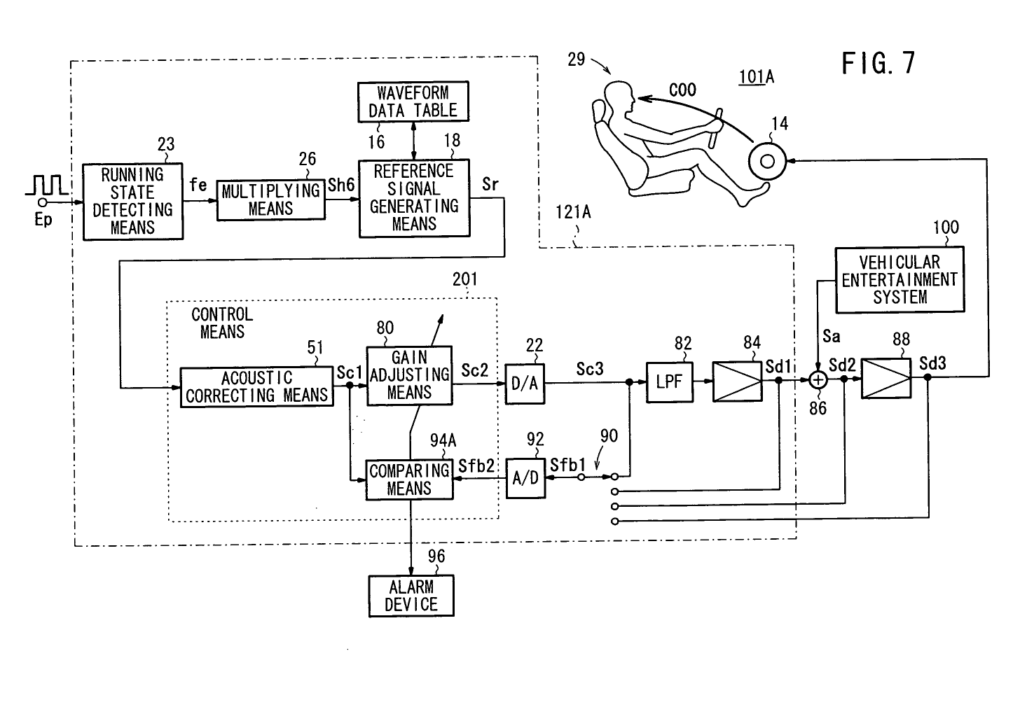

As shown in FIG. 7, a vehicular active sound control apparatus 101A according to a second embodiment of the present invention differs from the vehicular active sound control apparatus 101 according to the first embodiment shown in FIG. 1 in that the switch 79 is replaced with a gain adjusting means (variable gain amplifying means) 80 for changing the value (magnitude or amplitude) of the control signal Sc1 based on the output signal from a comparing means 94A and outputting the changed control signal Sc1 as the control signal Sc2.

The comparing means 94A is supplied with the control signal Sc1 and the feedback signal Sfb2. The comparing means 94A determines whether the amplification ratio Sfb2(Sc3)/Sc1, Sfb2(Sd1)/Sc1, Sfb2(Sd2)/Sc1, or Sfb2(Sd3)/Sc1 of the feedback signal Sfb2(Sc3), Sfb2(Sd1), Sfb2(Sd2), or Sfb2(Sd3) to the control signal Sc1 falls in a predetermined range or not. If the amplification ratio does not fall in the predetermined range, then the comparing means 94A adjusts the gain of the gain adjusting means 80 to bring the amplification ratio into the predetermined range, thereby controlling the control signal Sc3 or the drive signal Sd1, Sd2, or Sd3 to have a predetermined value. The gain of the gain adjusting means 80 has a default value of 0 [dB].

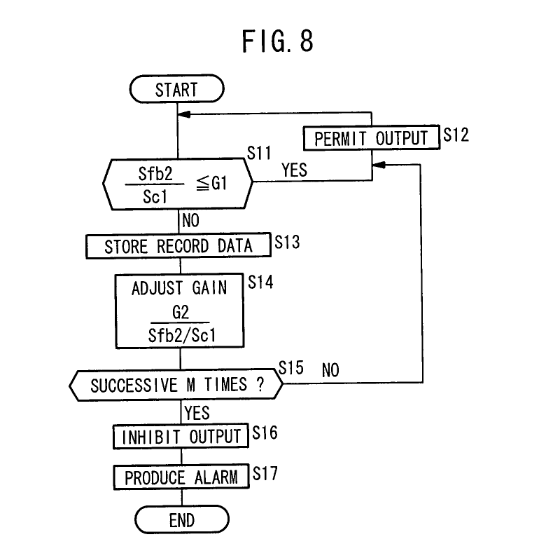

Operation of the comparing means 94A will be described below with reference to a flowchart shown in FIG. 8.

While the vehicular active sound control apparatus 101A is in operation, the control signal Sc1 output from the control means 201 is processed into the control signal Sc2 whose value (magnitude) has been adjusted by the gain adjusting means 80. The control signal Sc2 is then converted by the D/A converter 22 into the control signal Sc3, which passes through the low-pass filter 82 and is amplified into the drive signal Sd1 by the preamplifier 84.

The drive signal Sd1 and the audio signal Sa are mixed by the mixer 86 into the drive signal Sd2, which is amplified by the main amplifier 88 into the drive signal Sd3. The speaker 14 outputs a sound effect based on the drive signal Sd3.

While the vehicular active sound control apparatus 101A is thus in operation, in step S11, the multiplexer 90 selects one of the control signal Sc3 and the drive signals Sd1, Sd2, Sd3 as the feedback signal Sfb1 (Sc3, Sd1, Sd2, or Sd3), which is converted by the A/D converter 92 into the feedback signal Sb2 (Sc3, Sd1, Sd2, or Sd3) that is supplied to the comparing means 94A of the control means 201, which determines the ratio (amplification ratio) Sfb2/Sc1 of the feedback signal Sfb2 to the control signal Sc1.

Then, the comparing means 94A determines whether the amplification ratio Sfb2/Sc1 corresponding to each of the control signal Sc3 and the drive signals Sd1, Sd2 and Sd3, is smaller than an amplification ratio upper limit G1 that has been determined in advance therefor or not, as indicated by the following expression (1):

(Sfb2/Sc1)≦G1 (1)

If the amplification ratio Sfb2/Sc1 is equal to or smaller than the amplification ratio upper limit G1, then it is judged that the amplification ratio Sfb2/Sc1 falls in a normal range. In step S12, the control means 201 permits the control signal Sc2 to be output from the gain adjusting means 80. Therefore, the vehicular active sound control apparatus 101A continuously outputs the sound effect from the speaker 14.

If the amplification ratio Sfb2/Sc1 exceeds the amplification ratio upper limit G1 in step S11, then the detected value of the amplification ratio Sfb2/Sc1 is stored as record data in a memory in step S13.

In step S14, the gain adjusting means 80 lowers the present gain Sfb2/Sc1 to a gain G2/(Sfb2/Sc1) in order to satisfy the condition in step S11 in view of the effects of aging, noise, etc. (the value of G2 is a fixed value satisfying the range G1<G2<2×G1).

Then, in step S15, it is determined whether the condition in step S11 has been satisfied successively a predetermined number m of times (m≧2) or not. If the condition in step S11 has not been satisfied successively the predetermined number m of times, then the processing loop from step S12 is continuously executed (from S12 to S11 to S13 to S14 to S15). If the condition in step S11 has been satisfied the predetermined number m of times, then the gain adjusting means 80 is turned off to set the control signal Sc2 to zero, i.e., to inhibit the control signal Sc2 from being output in step S16.

In step S17, the alarm device 96 indicates an abnormal output state.

According to the second embodiment, as described above, the control means 201 calculates the amplification ratio Sfb2/Sc1 of the feedback signal Sfb2, i.e., either one of the control signal Sc3 and the drive signals Sd1, Sd2, Sd3, to the control signal Sc1, and adjusts the gain of the gain adjusting means 80 depending on the calculated amplification ratio Sfb2/Sc1 to convert the control signal Sc1 into the adjusted control signal Sc2. As a result, the value of either one of the control signal Sc3 and the drive signals Sd1, Sd2, Sd3 which is selected as the feedback signal Sfb1 can be adjusted to a desired value.

Since the alarm device 96 is activated when the amplification ratio Sfb2/Sc1 has exceeded the amplification ratio upper limit G1 successively the predetermined number m of times, it is possible to accurately determine whether the preamplifier 84, the mixer 86, or the main amplifier 88, which is an active component placed between the control signal Sc3 and the drive signal Sd3, has failed or not.

As the amplification ratio Sfb2/Sc1 of either one of the drive signals Sd1, Sd2, Sd3 to the control signal Sc1 is determined, it is possible to absorb aging of parts and performance variations of mass-produced parts of either one of the preamplifier 84, the mixer 86 for mixing the drive signal Sd1 with the audio signal Sa from the vehicular entertainment system 100, and the main amplifier 88 for driving the speaker 14. Therefore, even if a wrong part is installed, the speaker 14 can be prevented from outputting an abnormal sound, but is capable of outputting a normal sound.

According to the first and second embodiments, the vehicular active sound control apparatus can be prevented from generating an uncomfortable sound due to active sound control failures. The vehicular active sound control apparatus can prevent the speaker 14 from outputting an abnormal sound, i.e., an uncomfortable sound, and allows the speaker 14 to output a normal sound, i.e., a normal sound effect.

Although certain preferred embodiments of the present invention have been shown and described in detail, it should be understood that various changes and modifications may be made therein without departing from the scope of the appended claims.

What is claimed is:

1. A vehicular active sound control apparatus comprising:
a waveform data table for storing waveform data in one cyclic period;
reference signal generating means for generating a reference signal by successively reading the waveform data from said waveform data table;
running state detecting means for detecting a running state of a vehicle;
control means for generating a control signal by acoustically changing said reference signal depending on the running state of the vehicle detected by said running state detecting means; and
output means for acoustically outputting a drive signal based on said control signal;
wherein said control means inhibits said control signal from being generated if a value of said drive signal has exceeded a predetermined threshold successively a predetermined number of times.

2. A vehicular active sound control apparatus according to claim 1, further comprising alarm means for generating an alarm signal,
wherein said control means activates said alarm means if the value of said drive signal has exceeded the predetermined threshold successively the predetermined number of times.

3. A vehicular active sound control apparatus according to claim 1, further comprising an amplifier for amplifying said control signal at a predetermined amplification ratio and outputting the amplified control signal,
wherein said drive signal comprises said amplified control signal.

4. A vehicular active sound control apparatus according to claim 1, further comprising:
a vehicular entertainment system including an audio signal source; and
a mixer for mixing an audio signal from said audio signal source and said control signal or an amplified control signal with each other and outputting a mixed signal;
wherein said drive signal comprises said mixed signal.

5. A vehicular active sound control apparatus comprising:
a waveform data table for storing waveform data in one cyclic period;
reference signal generating means for generating a reference signal by successively reading the waveform data from said waveform data table;
running state detecting means for detecting a running state of a vehicle;
control means for generating a control signal by acoustically changing said reference signal depending on the running state of the vehicle detected by said running state detecting means; and
output means for acoustically outputting a drive signal based on said control signal;
wherein said control means calculates an amplification ratio of said control signal and said drive signal, and adjusts a value of said control signal depending on the calculated amplification ratio.

6. A vehicular active sound control apparatus according to claim 5, further comprising alarm means for generating an alarm signal,
wherein said control means activates said alarm means if said amplification ratio exceeds a predetermined value.

7. A vehicular active sound control apparatus according to claim 5, further comprising an amplifier for amplifying said control signal at a predetermined amplification ratio and outputting the amplified control signal,
wherein said drive signal comprises said amplified control signal.

8. A vehicular active sound control apparatus according to claim 5, further comprising:
a vehicular entertainment system including an audio signal source; and
a mixer for mixing an audio signal from said audio signal source and said control signal or an amplified control signal with each other and outputting a mixed signal;
wherein said drive signal comprises said mixed signal.
